(19) United States
(12) Patent Application Publication
(10) Pub. No.: US 2020/0124435 A1
(43) Pub. Date: Apr. 23, 2020

(54) DISTRIBUTED ROUTE DETERMINATION SYSTEM

(71) Applicant: Toyota Motor North America, Inc., Plano, TX (US)

(72) Inventor: Michael C. Edwards, McKinney, TX (US)

(21) Appl. No.: 16/163,363

(22) Filed: Oct. 17, 2018

(51) Int. Cl. G01C 21/34; G08G 1/01; G08G 1/0965; G08G 1/0968; G08G 1/0969

(52) U.S. Cl. CPC G01C 21/3492; G01C 21/3415; G08G 1/0112; G08G 1/0969; G08G 1/0965; G08G 1/096844; G08G 1/0141

(57) ABSTRACT

Methods and systems for determining a suggested route for a vehicle from a start location to a destination location. The system includes a transceiver configured to receive, from one or more other vehicles, route condition data including one or more indicators of future traffic conditions between the start location and the destination location. The system includes an ECU configured to determine a baseline best route based on historical traffic data. The ECU is configured to determine whether the route condition data indicates travelling along the baseline best route will result in a delay. The ECU is configured to determine the suggested route to be a new projected route based on the route condition data when the route condition data indicates travelling along the baseline best route will result in the delay. The system also includes a display configured to display the suggested route.

### BACKGROUND

### 1. Field

This specification relates to a system and a method for determining a navigation route using distributed computing devices.

### 2. Description of the Related Art

Conventionally, navigation systems receive traffic data from a third party data service and determine a fastest route from a start location (often the current location of the vehicle) to a destination location. These conventional navigation systems may update based on changing traffic conditions, but these conventional navigation systems are reactive in nature, and only assess route travel time based on currently available traffic data. Furthermore, there is a lag between when traffic congestion begins in the real world and when the traffic data received by the conventional navigation system reflects the traffic congestion. Because of this lag, vehicles using conventional navigation systems may encounter traffic that exists in the real world, but the conventional navigation system is not yet aware of. Accordingly, there is a need for improved route determination.

### SUMMARY

What is described is a system for determining a suggested route for a vehicle from a start location to a destination location. The system includes a transceiver of the vehicle configured to receive, from one or more other vehicles, route condition data including one or more indicators of future traffic conditions along a plurality of candidate routes between the start location and the destination location. The system also includes an electronic control unit (ECU) of the vehicle connected to the transceiver. The ECU is configured to determine a baseline best route under baseline conditions of travel based on historical traffic data. The ECU is also configured to determine whether the route condition data indicates travelling along the baseline best route will result in a delay exceeding a threshold amount of time. The ECU is also configured to determine the suggested route to be a new projected route based on the route condition data when the route condition data indicates travelling along the baseline best route will result in the delay exceeding the threshold amount of time. The system also includes a display located within the vehicle, connected to the ECU, and configured to display the suggested route.

Also described is a vehicle associated with a user desiring to travel from a start location to a destination location. The vehicle includes a transceiver configured to receive, from one or more other vehicles, route condition data including one or more indicators of future traffic conditions along a plurality of candidate routes between the start location and the destination location. The vehicle also includes an electronic control unit (ECU) connected to the transceiver. The ECU is configured to determine a baseline best route under baseline conditions of travel based on historical traffic data. The ECU is also configured to determine whether the route condition data indicates travelling along the baseline best route will result in a delay exceeding a threshold amount of time. The ECU is also configured to determine the suggested route to be a new projected route based on the route condition data when the route condition data indicates travelling along the baseline best route will result in the delay exceeding the threshold amount of time, or determine the suggested route to be the baseline best route when the route condition data indicates travelling along the baseline best route will result in a delay under the threshold amount of time.

Also described is a method for determining a suggested route for a vehicle from a start location to a destination location. The method includes determining, by an electronic control unit (ECU) of the vehicle, a baseline best route under baseline conditions of travel based on historical traffic data. The method also includes receiving, by a transceiver of the vehicle, from one or more other vehicles, route condition data including one or more indicators of future traffic conditions along a plurality of candidate routes between the start location and the destination location. The method also includes determining, by the ECU, whether the route condition data indicates travelling along the baseline best route will result in a delay exceeding a threshold amount of time. The method also includes determining, by the ECU, the suggested route to be a new projected route based on the route condition data when the route condition data indicates travelling along the baseline best route will result in the delay exceeding the threshold amount of time. The method also includes displaying, by a display located within the vehicle, the suggested route.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIGS. 1A-1E illustrate a process for determining a suggested route using traffic data detected at the time of departure, according to various embodiments of the invention.

FIG. 2A illustrates a representation of a baseline best route under baseline conditions of travel based on historical traffic data, according to various embodiments of the invention.

FIG. 2B illustrates a first possible anticipated traffic condition based on route condition data detected by a plurality of vehicles along the routes, according to various embodiments of the invention.

FIG. 2C illustrates a second possible anticipated traffic condition based on route condition data detected by a plurality of vehicles along the routes, according to various embodiments of the invention.

FIG. 2D illustrates a third possible anticipated traffic condition based on route condition data detected by a plurality of vehicles along the routes, according to various embodiments of the invention.

FIG. 3 illustrates vehicles communicating with each other and detecting route condition data, according to various embodiments of the invention.

FIG. 4 illustrates the components of the distributed route determination system, according to various embodiments of the invention.

FIG. 5 illustrates a flow diagram of a process performed by the distributed route determination system, according to various embodiments of the invention.

### DETAILED DESCRIPTION

Disclosed herein are systems, vehicles, and methods for determining a navigation route using distributed computing devices. The systems, vehicles, and methods described herein detect whether the vehicle is driven on a regular schedule (e.g., a commute from a user's home to a user's work). The systems, vehicles, and methods described herein then determine a default best route based on historical traffic data. Then, on a given day, the systems, vehicles, and methods described herein determine whether the given day is expected to be similar to a typical day. When the given day is expected to be similar to a typical day, the default best route is suggested. When the given day is not expected to be similar to a typical day, alternate routes are considered, and the default best route may not be used.

The systems, vehicles, and methods described herein leverage a distributed network of route condition data gathering vehicles to determine a projection of traffic conditions along one or more routes (including the default best route) during the user's commute. The projection of traffic conditions based on the detected route condition data is more representative of the user's experience during the user's commute than conventional systems. The distributed nature of the route condition data collection and distribution allows for more efficient computing, and therefore lower latency between what is detected in the real world and what is reflected by the system when making route suggestion determinations.

By providing more accurate and more responsive route suggestions, the systems and methods described herein, if used by a critical mass of vehicles and users, may decrease overall traffic congestion levels by more evenly distributing the flow of vehicles along various routes. As used herein, a route may refer to a road connecting a first location to a second location.

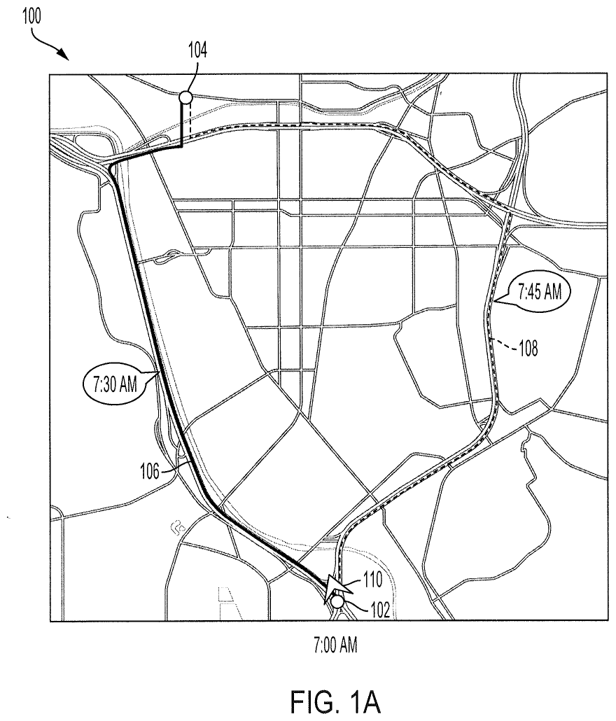

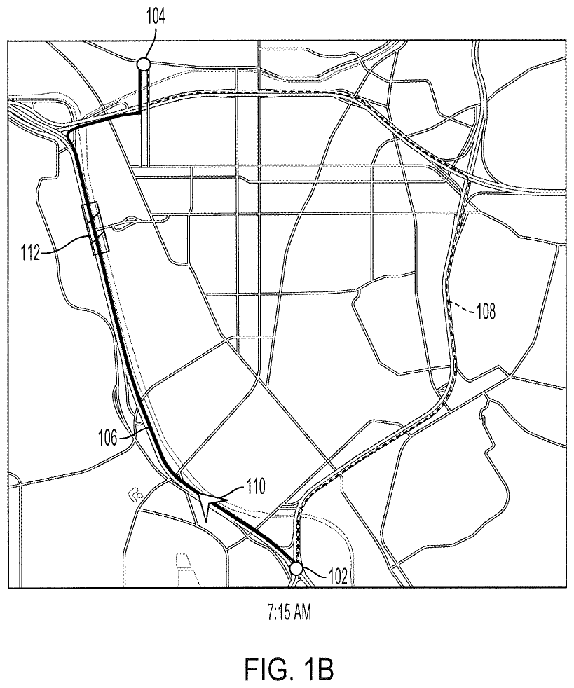

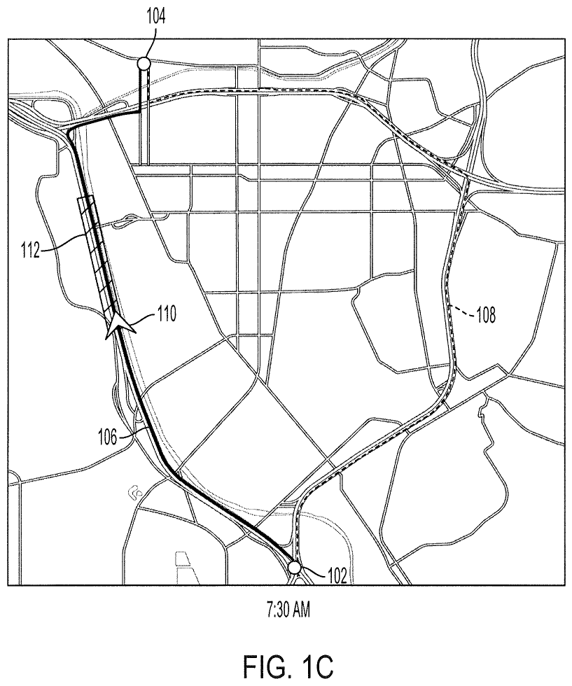

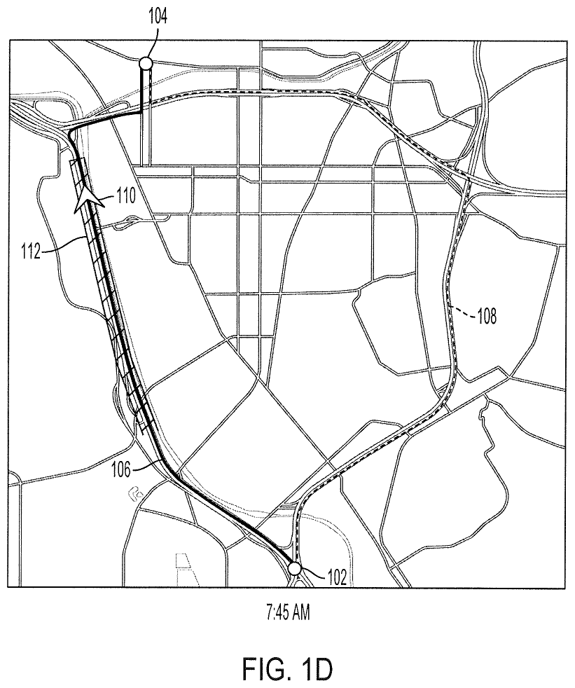

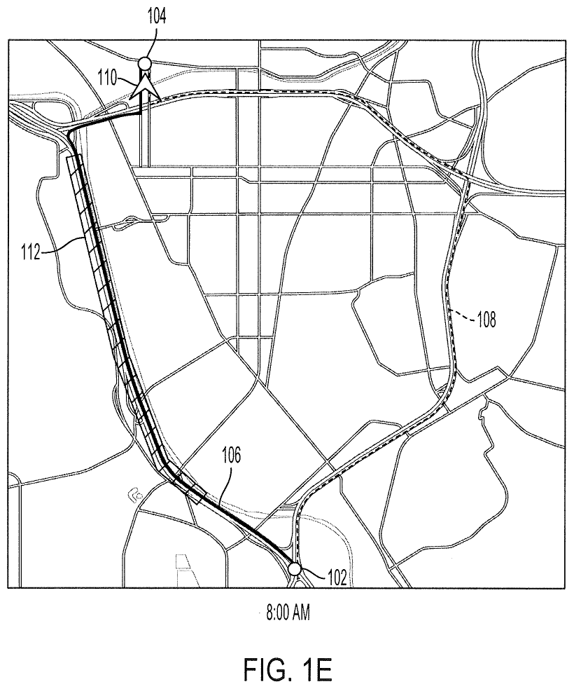

FIG. 1A illustrates a map 100 showing a current location of a vehicle 110, a start location 102, a destination location 104, a first route 106, and a second route 108 at 7:00 AM. The vehicle 110, based on traffic data and conventional methods of determining route suggestions, determines that if the vehicle 110 takes the first route 106, the vehicle 110 will arrive at the destination location 104 at 7:30 AM. The vehicle 110 also determines that if the vehicle 110 takes the second route 108, the vehicle 110 will arrive at the destination location 104 at 7:45 AM. This is because the second route 108 is longer than the first route 106, and there is currently no traffic on either route. Accordingly, the vehicle 110 may recommend taking the first route 106.

FIG. 1B illustrates the vehicle 110 travelling along the first route 106 at 7:15 AM. There is a relatively small area of the first route 106 where traffic 112 is located. The second route 108 has no traffic.

FIG. 1C illustrates the vehicle 110 travelling along the first route 106 at 7:30 AM. The traffic 112 has grown between 7:15 AM and 7:30 AM, and the vehicle 110 is in the traffic 112 at 7:30 AM. The second route 108 has no traffic.

FIG. 1D illustrates the vehicle 110 travelling along the first route 106 at 7:45 AM. The traffic 112 has further grown between 7:30 AM and 7:45 AM. The vehicle 110 is almost past the traffic 112. At this point, the vehicle 110 would have been better off taking the second route 108, as the second route 108 did not experience any delays, and the vehicle 110 would have arrived at the destination location 104 at 7:45 AM.

FIG. 1E illustrates the vehicle 110 arriving at the destination location 104 at 8:00 AM. Had the vehicle 110 taken the second route 108, the vehicle 110 would have reached the destination location 104 sooner. However, at the time the decision was made to take the first route 106 over the second route 108, the first route 106 appeared to be the better choice.

The systems and methods described herein provide an improvement on conventional methods of determining routes in order to provide a better-informed and ultimately more accurate recommendation of a suggested route from a start location to a destination location.

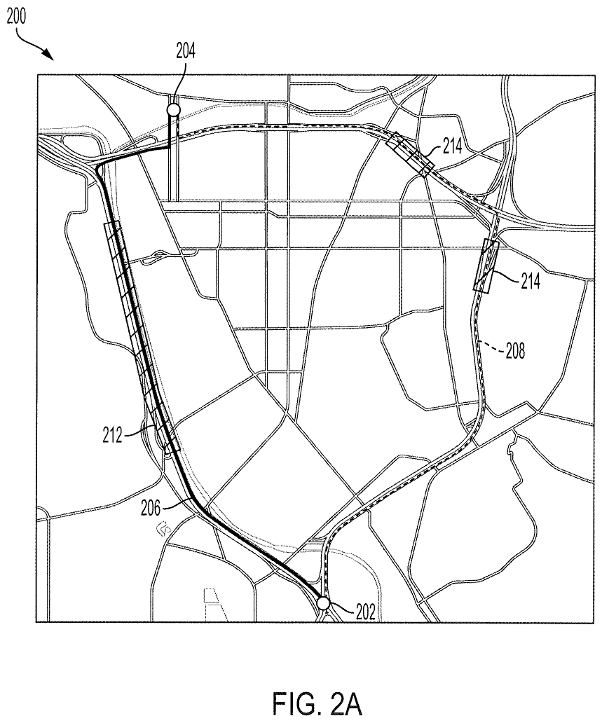

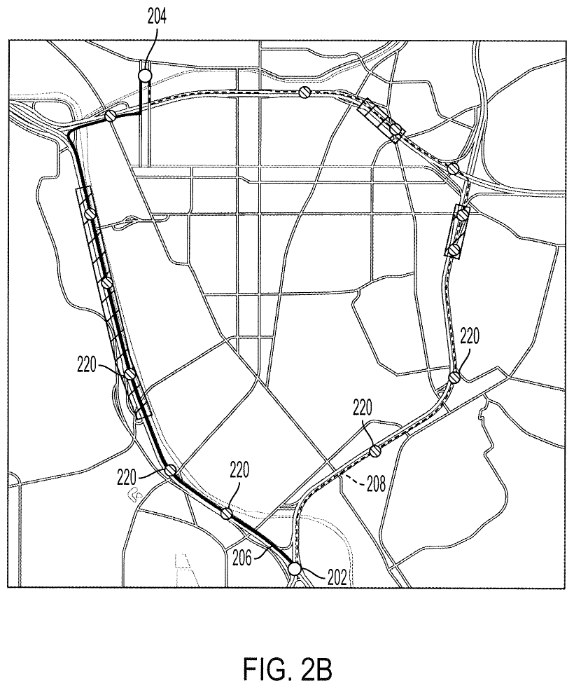

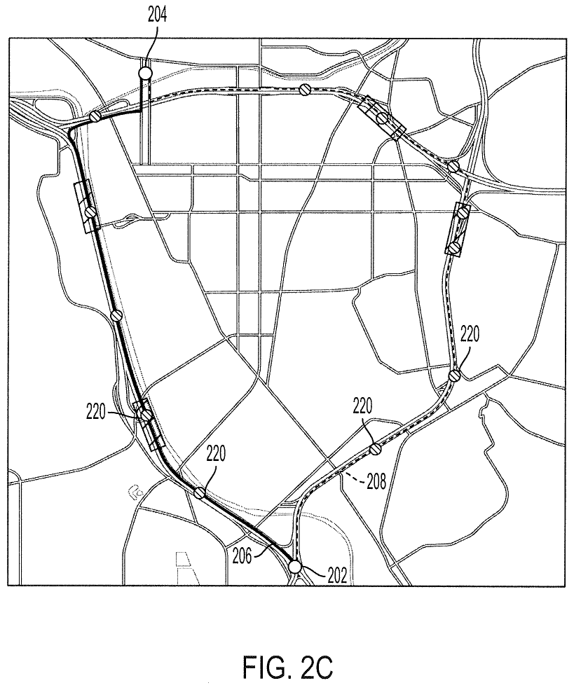

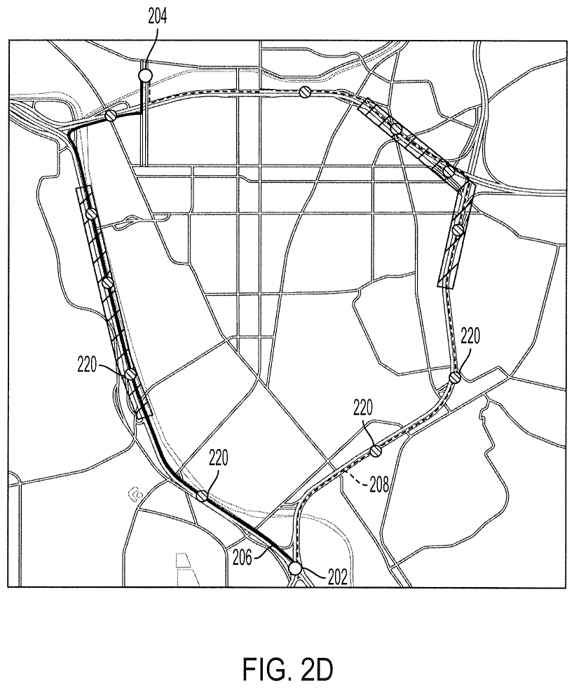

FIG. 2A illustrates a map 200 showing the expected traffic during a typical commute of a vehicle from a start location 202 to a destination location 204. The vehicle may keep track of its location over time to determine trends. For example, the vehicle may determine that every weekday at 7:00 AM, the vehicle is driven from the start location 202 to the destination location 204. In some embodiments, the vehicle may not determine that there is a trend until a threshold number of driving occurrences from a particular start location to a particular destination location is performed. In some embodiments, a user of the vehicle may indicate to the vehicle the user's commuting schedule.

The vehicle may also determine the traffic patterns typically present during the user's commuting schedule. These traffic patterns may change during the user's commute (i.e., between when the vehicle leaves the start location and arrives at the destination location). Accordingly, the traffic patterns may be a series of traffic conditions over a period of time. Alternatively, or in addition, the traffic patterns may be represented as an average of the traffic conditions over the period of time during the user's commute.

FIG. 2A illustrates the average amount of traffic on the first route 206 and the second route 208 during the user's commuting schedule. That is, FIG. 2A illustrates the traffic the user is likely to experience when leaving the start location. This is a more accurate indication of the user's traffic experience, compared to the current traffic conditions shown when the user leaves the start location, as shown in FIG. 1A.

In some embodiments, the traffic patterns are determined and stored by the vehicle each time the user travels from the start location 202 to the destination location 204 according to the user's commuting schedule. For example, if the user's commuting schedule is on weekdays leaving the start location 202 at 8:00 AM, the vehicle may record the traffic patterns of the first route 206 and the traffic patterns of the second route 208 each time the user commutes from the start location 202 to the destination location 204 at 8:00AM on weekdays.

In some embodiments, the traffic patterns are recorded by a third party, and the vehicle may have access to this traffic pattern data. The third party may monitor traffic conditions for every route at all times of the day, and the vehicle may request traffic patterns from a start location to a destination location at a particular time. The third party may then provide the requested traffic patterns to the vehicle.

According to the traffic patterns represented by the map 200 of FIG. 2A, on a typical day, while travelling from the start location 202 to the destination location 204, the vehicle may expect to encounter traffic 212 along the first route 206, and traffic 214 along the second route 208. Even though the second route 208 is longer, the traffic 214 along the second route 208 is considerably less than the traffic 212 along the first route 206. Accordingly, the vehicle may suggest taking the second route 208 on a typical day, as the second route 208 will result in a shorter time from the start location 202 to the destination location 204. The suggested route to take on a typical day may be referred to herein as a baseline best route, and the route conditions of a typical day may be referred to as baseline conditions.

Suggesting the second route 208 each day, regardless of the particular day's traffic conditions would, over time, result in an aggregate of improved commuting times for the user of the vehicle, as compared to the conventional methods illustrated in FIGS. 1A-1E. However, the systems and methods described herein may further take into account the anticipated traffic conditions of a particular day, and may adjust the recommendation of the route to take based on the anticipated traffic conditions of the particular day.

FIG. 2B illustrates a plurality of other vehicles 220 currently travelling along the first route 206 and the second route 208 on a particular day. The other vehicles 220 may detect and report route conditions. The other vehicles 220 may provide their own travelling velocities in order to provide a current route condition along the first route 206 and the second route 208. However, more importantly, the other vehicles 220 may detect route condition data. The route condition data may include a number of vehicles on the first route 206 and the second route 208. The number of vehicles on a given road is the strongest indicator of future traffic. The route condition data may also include the presence of any delay-causing events or objects in the road, as detected by the other vehicles 220. The other vehicles 220 may determine an approximate delay that can be expected due to the delay-causing events or objects. In some embodiments, the other vehicles 220 use machine learning techniques to identify types of delay-causing events or objects and corresponding expected delays expected to be caused as a result of the delay-causing events or objects.

The vehicle at the start location 202 may receive the route condition data from the other vehicles 220 and may determine whether this particular day is a typical day having baseline conditions and whether the typical traffic patterns illustrated in FIG. 2A can be expected. In general, the route condition data includes one or more indicators (e.g., amount of traffic congestion and/or the presence of delay-causing objects or events) of future traffic conditions along a plurality of candidate routes between the start location 202 and the destination location 204.

As illustrated in FIG. 2B, the route condition data from the other vehicles 220 indicates that traffic may be expected in approximately the same locations as a typical day. The other vehicles 220 may detect a number of vehicles on the road, and the number of vehicles on the road may be consistent with historical vehicle congestion data. Accordingly, the system may recommend the vehicle travel along the second route 208.

FIG. 2C illustrates a plurality of other vehicles 220 currently travelling along the first route 206 and the second route 208 on a different day. On this day, the route condition data from the other vehicles 220 on the second route 208 indicates a typical day of traffic along the second route 208 is to be expected. However, the route condition data from the other vehicles 220 on the first route 206 indicates a lighter than average day of traffic along the first route 206 is to be expected. The other vehicles 220 may detect fewer vehicles on the first route 206 on this day as compared to the historical vehicle congestion data. Accordingly, the vehicle may determine that based on the route condition data received from the other vehicles 220, the first route 206 will have a significantly smaller amount of traffic as compared to a typical day, and the first route 206 is now faster than the second route 208 on this day. The vehicle, in turn, suggests travelling along the first route 206.

FIG. 2D illustrates a plurality of other vehicles 220 currently travelling along the first route 206 and the second route 208 on another different day. On this another day, the route condition data from the other vehicles 220 on the first route 206 indicates a typical day of traffic along the first route 206 is to be expected. That is, the detected route condition data of the first route 206 is consistent with the baseline conditions. However, the route condition data from the other vehicles 220 on the second route 208 indicates a heavier than average day of traffic along the second route 208 is to be expected. The other vehicles 220 may detect a more than average number of vehicles on the second route 208 on this day and/or the presence of a delay-causing event or object. Accordingly, the vehicle may determine that based on the route condition data received from the other vehicles 220, the second route 208 will have a significantly greater amount of traffic as compared to a typical day, and the first route 206 is now faster than the second route 208 on this day. The vehicle, in turn, suggests travelling along the first route 206.

In some embodiments, the vehicle may not suggest using a different route than the baseline best route used on a typical day unless an anticipated delay along the baseline best route exceeds a threshold amount of time. For example, if it takes 30 minutes to travel along the baseline best route on a typical day, but on this particular day, the route condition data indicates that it may take an additional 10 minutes to travel along the baseline best route, the additional 10 minutes is compared against the threshold amount of time. If the threshold amount of time is 5 minutes, then the vehicle may determine a new projected route to take. If the threshold amount of time is 15 minutes, then the vehicle may remain on the baseline best route. In some embodiments, the threshold amount of time is a percentage increase of time instead of an absolute time measurement. For example, the threshold amount of time may be a 10% increase in travel time or a 5% increase in travel time.

The other vehicles 220 providing the route condition data to the user's vehicle before the user's vehicle departs the start location allows the user's vehicle to make the best possible route suggestion. The route condition data from the other vehicles 220 is more robust than conventional traffic data because it detects a number of other vehicles on the road and/or the presence of delay-causing events or objects. The number of other vehicles on the road may be an absolute value (e.g., 20 vehicles in a one-mile radius) or may be a relative value (e.g., 2 fewer vehicles in a 10-foot radius as compared to a typical day).

In some embodiments, the route condition data from the other vehicles 220 may be verified against map data or other supplemental data to determine whether there is an explanation for any detected congestion or slowdowns. For example, if the route condition data indicates congestion at a particular location, the vehicle may check the map data at the particular location to determine whether there is an explanation, such as a decreasing of the number of lanes on the road, or a stop sign.

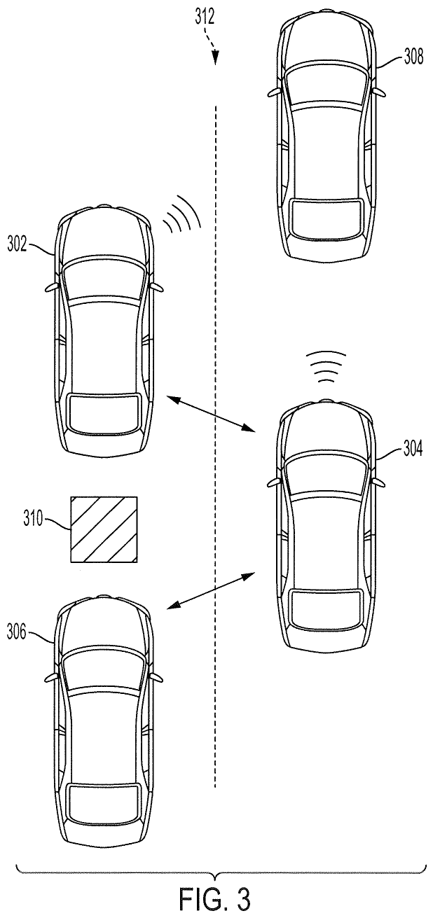

FIG. 3 illustrates a plurality of vehicles on a road. There is a first vehicle 302, a second vehicle 304, a third vehicle 306, and a fourth vehicle 308.

The first vehicle 302, the second vehicle 304, and the third vehicle 306 may be configured to communicate with each other. These vehicles may communicate with each other using a communications protocol, such as dedicated short-range communications (DSRC). These vehicles may provide route condition data to each other, similar to the other vehicles 220 of FIGS. 2B-2D. These vehicles may also be configured to detect the presence of other vehicles in their vicinity, as well as possible delay-causing events or objects. For example, the first vehicle 302 and the second vehicle 304 may detect the presence of the fourth vehicle 308. The fourth vehicle 308 may not be capable of detecting and providing route condition data to other vehicles, and thus is unlike the other vehicles 220 of FIGS. 2B-2D.

The first vehicle 302, the second vehicle 304, and the third vehicle 306 may travel along the road 312 at a particular frequency (e.g., every day, every weekday, every weekend day), and the first vehicle 302, the second vehicle 304, and the third vehicle 306 may track a number of vehicles in their vicinity each time they travel along the road 312. On this particular day, the presence of the fourth vehicle 308 is detected by the first vehicle 302 and the second vehicle 304. The detection of the fourth vehicle 308 represents an increase in vehicle density on this particular day, as compared to a typical day. Accordingly, the first vehicle 302 may communicate to the second vehicle 304 route condition data indicating that there are more vehicles on the route than normal. The second vehicle 304 may communicate to the third vehicle 306, which is unable to directly detect the presence of the fourth vehicle 308, route condition data indicating that there are more vehicles on the route than normal. Similarly, the third vehicle 306 may communicate the route condition data to other downstream vehicles until the route condition data reaches the user's vehicle at a time before the user's vehicle departs the start location and must decide which route to take. In this way, the communication of the route condition data is passed from one vehicle to another and does not rely on communication with a central server, which may become congested from the heavy flow of data to and from the central server. In addition, direct communication from vehicle to vehicle obviates concerns regarding inaccessibility of the central server for any reason, such as down time for maintenance.

The third vehicle 306 may also detect the presence of a delay-causing event or object 310. The third vehicle 306 may include the detected presence of the delay-causing event or object 310 in its route condition data communicated to other vehicles.

The first vehicle 302, the second vehicle 304, and the third vehicle 306 may use image sensors, such as a camera, or spatial sensors, such as LIDAR, to detect the presence of other vehicles and/or delay-causing objects or events.

In some embodiments, when the vehicles are parked or located at a designated location, such as home or work, the vehicles may communicate their detected and received route condition data to a remote data server. The vehicles may also communicate their travelling velocities during their commute to the remote data server. The remote data server may aggregate the detected and received route condition data from the various vehicles to determine the best route for a typical day (e.g., the baseline best route). The remote data server may periodically update the determination of the best route for a typical day, and if typical traffic patterns experience enough change, the best route for a typical day may change.

In some embodiments, when the vehicles are parked or otherwise not being used, the ECU of the parked or unused vehicle may be used by a nearby vehicle to bear some of the computational load of the nearby vehicle in determining route condition data, projected routes, and/or projected traffic conditions.

Because of the downstream communication from vehicle to vehicle of the route condition data, the user's vehicle has information about the projected traffic conditions based on the presence of other upstream vehicles. Similarly, when the user's vehicle passes the route condition data detected by the user's vehicle to other downstream vehicles, the other downstream vehicles are able to make routing decisions based on the presence of the user's vehicle. This distributed architecture creates a naturally load-evening system where downstream vehicles are aware of the anticipated upcoming traffic conditions in real time. A central architecture where a central server determines which route to suggest based on a current traffic condition at the time of departure may create a situation where future vehicles are all directed to a particular alternate route, thereby unintentionally creating traffic on the alternate route. This unintentionally created traffic may ultimately be worse than the original traffic that was meant to be avoided.

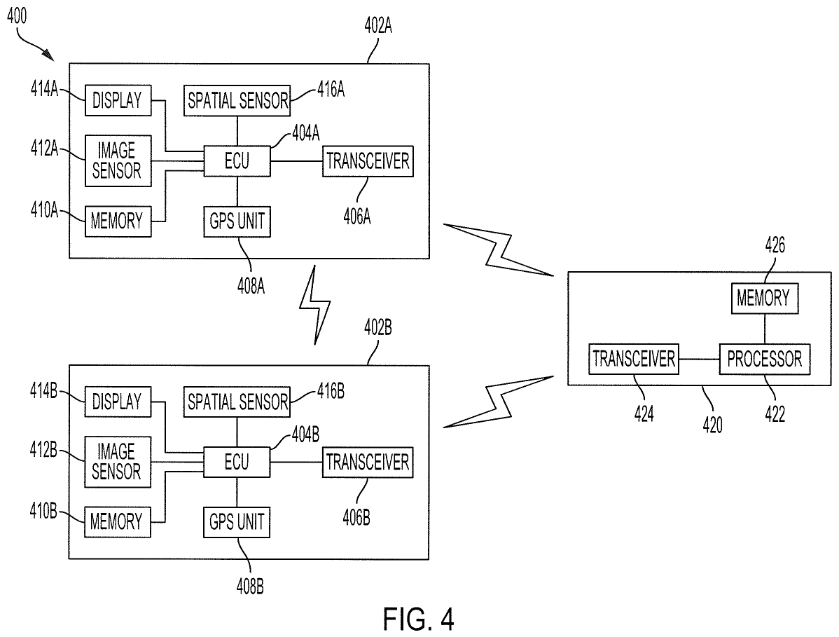

FIG. 4 illustrates a block diagram of the system 400. The system 400 includes a first vehicle 402A and a second vehicle 402B. Components having a letter suffix may be referred to collectively or individually by the number before the letter suffix. For example, vehicle 402 may refer to the first vehicle 402A and the second vehicle 402B collectively or may refer to either the first vehicle 402A or the second vehicle 402B individually.

The vehicle 402 may have an automatic or manual transmission. The vehicle 402 is a conveyance capable of transporting a person, an object, or a permanently or temporarily affixed apparatus. The vehicle 402 may be a self-propelled wheeled conveyance, such as a car, a sports utility vehicle, a truck, a bus, a van or other motor or battery driven vehicle. For example, the vehicle 402 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 402 may be semi-autonomous vehicle or an autonomous vehicle. That is, the vehicle 402 may be self-maneuvering and navigate without human input. An autonomous vehicle may use one or more sensors and/or a navigation unit to drive autonomously.

The vehicle 402 (e.g., first vehicle 402A and second vehicle 402B) includes an ECU 404 (e.g., ECU 404A and 404B) connected to a transceiver 406 (e.g., 406A and 406B), a GPS unit 408 (e.g., 408A and 408B), a memory 410 (e.g., 410A and 410B), an image sensor 412 (e.g., 412A and 412B), a display 414 (e.g., 414A and 414B), and a spatial sensor 416 (e.g., 416A and 416B). The ECU 404 may be one or more ECUs, appropriately programmed, to control one or more operations of the vehicle. The one or more ECUs 404 may be implemented as a single ECU or in multiple ECUs. The ECU 404 may be electrically coupled to some or all of the components of the vehicle. In some embodiments, the ECU 404 is a central ECU configured to control one or more operations of the entire vehicle. In some embodiments, the ECU 404 is multiple ECUs located within the vehicle and each configured to control one or more local operations of the vehicle. In some embodiments, the ECU 404 is one or more computer processors or controllers configured to execute instructions stored in a non-transitory memory 410.

The vehicle 402 may be coupled to a network. The network, such as a local area network (LAN), a wide area network (WAN), a cellular network, a digital short-range communication (DSRC), the Internet, or a combination thereof, connects the vehicle 402 to a remote data server 420.

The transceiver 406 may include a communication port or channel, such as one or more of a Wi-Fi unit, a Bluetooth® unit, a Radio Frequency Identification (RFID) tag or reader, a DSRC unit, or a cellular network unit for accessing a cellular network (such as 3G, 4G or 5G). The transceiver 406 may transmit data to and receive data from devices and systems not physically connected to the vehicle. For example, the ECU 404 may communicate with the remote data server 420. Furthermore, the transceiver 406 may access the network, to which the remote data server 420 is also connected.

The GPS unit 408 is connected to the ECU 404 and configured to determine location data. The ECU 404 may use the location data along with map data stored in memory 410 to determine a location of the vehicle. In other embodiments, the GPS unit 408 has access to the map data and may determine the location of the vehicle and provide the location of the vehicle to the ECU 404. The location data may be used by the ECU 404 when the ECU 404 performs any operation associated with navigation and route determination, such as recording historical traffic data along one or more routes, detecting route condition data, and determining the suggested route, for example.

The memory 410 is connected to the ECU 404 and may be connected to any other component of the vehicle. The memory 410 is configured to store any data described herein, such as the route condition data, the detected image data, the map data, the location data, the detected spatial data, the traffic pattern data, the historical vehicle congestion data, and any data received from the remote data server 420 or other vehicles via the transceiver 406 of the vehicle 402. The memory 410 may store a suggested route for a typical day, such as the second route 208 in FIG. 2A.

The vehicle 402 also includes an image sensor 412 configured to detect image data. The image sensor 412 may be one or more cameras configured to detect images of the environment outside of the vehicle 402. The image data may be used by the ECU 404 to determine route condition data.

The vehicle 402 also includes a spatial sensor 416 configured to detect spatial data. The spatial sensor 416 may be one or more spatial detection devices, such as RADAR or LIDAR configured to detect an environment outside of the vehicle 402. The spatial data may be used by the ECU 404 to determine route condition data.

The vehicle 402 also includes a display 414. The display 414 may display a map of the suggested route or a map of predicted traffic conditions based on the received route condition data from other vehicles. The display 414 may be a touchscreen configured to receive user input via one or more selectable icons. For example, the display 414 may display a selectable icon for receiving an indication from the user to switch to a new projected route instead of the baseline best route.

The route condition data, the detected image data, the location data, and the detected spatial data may be communicated from the vehicle 402 to the remote data server 420 via the transceiver 406 of the vehicle 402 and the transceiver 424 of the remote data server 420.

The remote data server 420 includes a processor 422 connected to a transceiver 424 and a memory 426. The processor 422 (and any processors described herein) may be one or more computer processors configured to execute instructions stored on a non-transitory memory. The memory 426 may be a non-transitory memory configured to store data associated with traffic along various routes. The memory 426 may store, for any number of particular time values, a typical baseline traffic condition for each route of a plurality of routes. For example, the memory 426 may store a typical baseline traffic condition for each of Routes A, B, and C at times t1, t2, t3, t4, t5, and t6. The transceiver 424 may be configured to transmit and receive data, similar to transceiver 406.

The processor 422 of the remote data server 420 may be configured to determine the traffic conditions of every route of a plurality of routes at numerous times in a typical day. For example, the processor 422 may determine a typical baseline traffic condition for each of Routes A, B, and C at times t1, t2, t3, t4, t5, and t6. The processor 422 may determine the typical baseline traffic conditions for the routes at the various times based on the route condition data received from the vehicles 402. In some embodiments, the processor 422 does not determine a typical traffic condition for a given route at a given time unless the processor 422 has a threshold number of observed data points.

As used herein, a “unit” may refer to hardware components, such as one or more computer processors, controllers, or computing devices configured to execute instructions stored in a non-transitory memory.

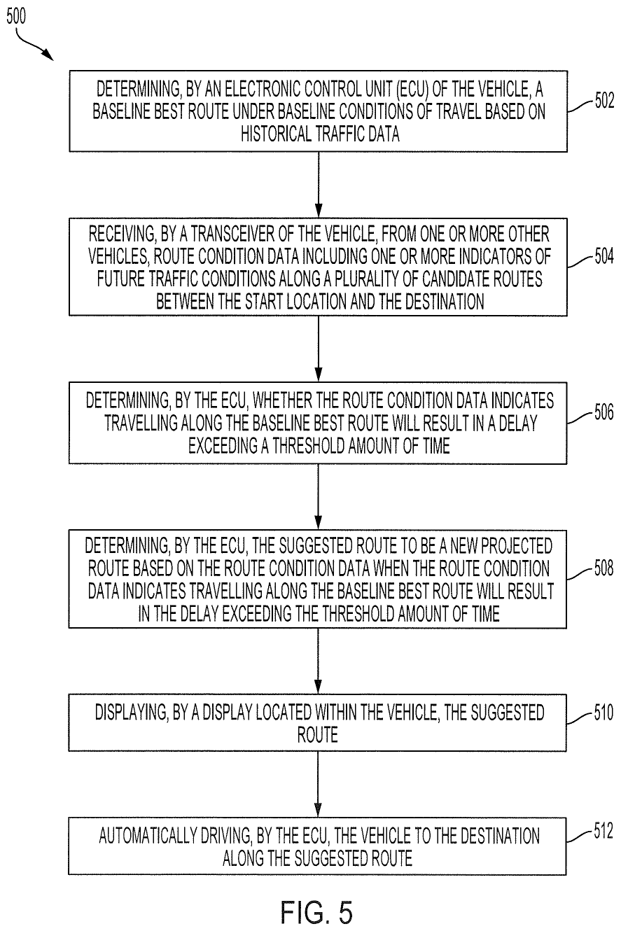

FIG. 5 is a flow diagram of a process 500 for a vehicle from a start location to a destination location. An electronic control unit (ECU) (e.g., ECU 404) of the vehicle (e.g., vehicle 402) determines a baseline best route under baseline conditions of travel based on historical traffic data (step 502). The baseline best route may correspond to a fastest route when typical baseline traffic conditions are present. One or more vehicles travelling along a route may detect and record historical traffic data. The parameters of the baseline conditions of travel may be determined and defined based on the historical traffic data.

A transceiver (e.g., transceiver 406) of the vehicle receives, from one or more other vehicles, route condition data including one or more indicators of future traffic conditions along a plurality of candidate routes between the start location and the destination location (step 504). The route condition data may include an indication of an amount of vehicles on the route and/or a presence of a delay-causing event or object. The one or more other vehicles may detect the route condition data using at least one of an image sensor or a spatial sensor. The one or more other vehicles may pass the route condition data from vehicle to vehicle until the route condition data is received by the transceiver. As the route condition data is received by a vehicle of the one or more other vehicles, the received route condition data may be supplemented with route condition data that the particular vehicle has detected, and the supplemented route condition data is then passed on to a next vehicle.

The ECU determines whether the route condition data indicates that travelling along the baseline best route will result in a delay exceeding a threshold amount of time (step 506). For example, the route condition data may indicate that the baseline best route has a higher congestion level than is present in the baseline condition, resulting in a projected delay were the vehicle to travel on the baseline best route, as compared to a typical day. The ECU may determine the delay by comparing the travel time in baseline conditions with a projected travel time based on the received route condition data. As described herein, the threshold amount of time may be a time measurement (e.g., 5 minutes, 10 minutes) or may be a relative amount (e.g., 10% longer time, 5% longer time). Due to uncertainty regarding determination of the projected delay based on the route condition data and common human preference for known routes, the baseline best route will be used unless the route condition data indicates a substantial delay, as measured by the threshold amount of time.

The ECU determines the suggested route to be a new projected route based on the route condition data when the route condition data indicates travelling along the baseline best route will result in the delay exceeding the threshold amount of time (step 508). In order to determine the new projected route, the ECU may determine projected travel times of a plurality of candidate routes between the start location and destination location using the route condition data associated with the plurality of candidate routes. The ECU may then select the fastest of the plurality of candidate routes as the suggested route.

When the route condition data indicates travelling along the baseline best route will result in a delay below the threshold amount of time (i.e., a delay less than the threshold amount of time, no delay, or a lower travel time than on a typical day) the baseline best route is used as the suggested route.

A display (e.g., display 414) within the vehicle displays the suggested route (step 510). The display of the suggested route may include turn-by-turn navigation guiding the driver along the suggested route. The display may be a display that is a part of the vehicle, such as a display of an infotainment unit. The display may be a display of a mobile device that is located within the passenger cabin of the vehicle.

When the vehicle is an autonomous or semi-autonomous vehicle, the ECU may automatically drive the vehicle to the destination location along the suggested route as soon as the suggested route is determined (step 512).

In some embodiments where transportation is provided as a service to users, be it using an autonomous vehicle or a non-autonomous vehicle, a particular user may be scheduled to be picked up based on a set schedule. For example, a person may be scheduled to be picked up at 6:30 AM every weekday morning to be taken to work by 7:15 AM. However, when the route condition data indicates that there will likely be a delay, either in picking up the user or dropping off the user at the destination location, the user may be offered an alternative transportation arrangement. For example, when the route condition data indicates that the vehicle to pick up the user will not be at the user's current location until 6:45 AM, an alternate vehicle which has room to accommodate the user may be offered for the user to ride in. In another example, the route condition data indicates that the vehicle will pick up the user at 6:30 AM, but will likely not be able to drop off the user until 7:30 AM due to projected traffic. The user may be offered a ride in another vehicle arriving at 6:00 AM which will be able to drop off the user at the destination location at 7:15 AM. In yet another example, the route condition data indicates that the vehicle will pick up the user at 6:30 AM, but will likely not be able to drop off the user until 7:30 AM due to projected traffic. The user may be offered an earlier pick-up time at 6:00 AM, which will allow the user to be dropped off at the destination location at 7:15 AM.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for determining a suggested route for a vehicle from a start location to a destination location, the system comprising:
a transceiver of the vehicle configured to receive, from one or more other vehicles, route condition data including one or more indicators of future traffic conditions along a plurality of candidate routes between the start location and the destination location;
an electronic control unit (ECU) of the vehicle connected to the transceiver and configured to:
determine a baseline best route under baseline conditions of travel based on historical traffic data,
determine whether the route condition data indicates travelling along the baseline best route will result in a delay exceeding a threshold amount of time, and
determine the suggested route to be a new projected route based on the route condition data when the route condition data indicates travelling along the baseline best route will result in the delay exceeding the threshold amount of time; and
a display located within the vehicle, connected to the ECU, and configured to display the suggested route.

2. The system of claim 1, wherein the ECU is further configured to determine the suggested route to be the baseline best route when the route condition data indicates travelling along the baseline best route will result in a delay under the threshold amount of time.

3. The system of claim 1, wherein the historical data includes traffic data of the plurality of candidate routes from the start location to the destination location over an anticipated travel time from the start location to the destination location, and
wherein the baseline best route is determined based on anticipated traffic along the plurality of candidate routes from the start location to the destination location over the anticipated travel time.

4. The system of claim 1, wherein the ECU is further configured to determine the new projected route by determining respective baseline travel times for the plurality of candidate routes from the start location to the destination location based on the historical traffic data, and adjusting each of the respective baseline travel times for the plurality of candidate routes based on the route condition data.

5. The system of claim 1, wherein the route condition data includes a vehicle congestion level relative to historical vehicle congestion levels.

6. The system of claim 1, wherein the route condition data includes a detection of one or more delay-causing events or objects.

7. The system of claim 1, wherein the one or more other vehicles each include at least one of an image sensor configured to detect image data, or a spatial sensor configured to detect spatial data of a surrounding environment, and
wherein each of the one or more other vehicles are configured to determine the route condition data based on the detected image data and/or the detected spatial data.

8. A vehicle associated with a user desiring to travel from a start location to a destination location, the vehicle comprising:
a transceiver configured to receive, from one or more other vehicles, route condition data including one or more indicators of future traffic conditions along a plurality of candidate routes between the start location and the destination location; and
an electronic control unit (ECU) connected to the transceiver and configured to:
determine a baseline best route under baseline conditions of travel based on historical traffic data,
determine whether the route condition data indicates travelling along the baseline best route will result in a delay exceeding a threshold amount of time, and
determine the suggested route to be a new projected route based on the route condition data when the route condition data indicates travelling along the baseline best route will result in the delay exceeding the threshold amount of time, or determine the suggested route to be the baseline best route when the route condition data indicates travelling along the baseline best route will result in a delay under the threshold amount of time.

9. The vehicle of claim 8, wherein the historical data includes traffic data of the plurality of candidate routes from the start location to the destination location over an anticipated travel time from the start location to the destination location, and
wherein the baseline best route is determined based on anticipated traffic along the plurality of candidate routes from the start location to the destination location over the anticipated travel time.

10. The vehicle of claim 8, wherein the ECU is further configured to determine the new projected route by determining respective baseline travel times for the plurality of candidate routes from the start location to the destination location based on the historical traffic data, and adjusting each of the respective baseline travel times for the plurality of candidate routes based on the route condition data.

11. The vehicle of claim 8, wherein the route condition data includes a vehicle congestion level relative to historical vehicle congestion levels.

12. The vehicle of claim 8, wherein the route condition data includes a detection of one or more delay-causing events or objects.

13. The vehicle of claim 8, further comprising at least one of an image sensor configured to detect image data, or a spatial sensor configured to detect spatial data of a surrounding environment,
wherein the ECU is further configured to determine updated route condition data based on the detected image data and/or the detected spatial data and the route condition data received from the one or more other vehicles, and
wherein the transceiver is further configured to communicate the updated route condition data to one or more additional vehicles.

14. The vehicle of claim 8, wherein the ECU is further configured to automatically drive toward the destination location along the suggested route upon determination of the suggested route.

15. A method for determining a suggested route for a vehicle from a start location to a destination location, the method comprising:
determining, by an electronic control unit (ECU) of the vehicle, a baseline best route under baseline conditions of travel based on historical traffic data;
receiving, by a transceiver of the vehicle, from one or more other vehicles, route condition data including one or more indicators of future traffic conditions along a plurality of candidate routes between the start location and the destination location;
determining, by the ECU, whether the route condition data indicates travelling along the baseline best route will result in a delay exceeding a threshold amount of time;
determining, by the ECU, the suggested route to be a new projected route based on the route condition data when the route condition data indicates travelling along the baseline best route will result in the delay exceeding the threshold amount of time; and
displaying, by a display located within the vehicle, the suggested route.

16. The method of claim 15, further comprising determining, by the ECU, the suggested route to be the baseline best route when the route condition data indicates travelling along the baseline best route will result in a delay under the threshold amount of time.

17. The method of claim 15, wherein the historical data includes traffic data of the plurality of candidate routes from the start location to the destination location over an anticipated travel time from the start location to the destination location, and
wherein the determination of the baseline best route is based on anticipated traffic along the plurality of candidate routes from the start location to the destination location over the anticipated travel time.

18. The method of claim 15, wherein the determining, by the ECU, of the new projected route includes determining respective baseline travel times for the plurality of candidate routes from the start location to the destination location based on the historical traffic data, and adjusting each of the respective baseline travel times for the plurality of candidate routes based on the route condition data.

19. The method of claim 15, wherein the route condition data includes a vehicle congestion level relative to historical vehicle congestion levels and/or a detection of one or more delay-causing events or objects.

20. The method of claim 15, further comprising:
detecting, by an image sensor of the vehicle, image data and/or detecting by a spatial sensor of the vehicle, spatial data of a surrounding environment;
determining, by the ECU, updated route condition data based on the detected image data and/or the detected spatial data and the route condition data received from the one or more other vehicles; and
communicating, by the transceiver, the updated route condition data to one or more additional vehicles.
